(19) United States
(12) Patent Application Publication
(10) Pub. No.: US 2026/0227266 A1
(43) Pub. Date: Aug. 6, 2026

(54) Apparatus, Systems and Methods to Monitor Methane Emissions from an Oil and Gas Production Tree

(71) Applicant: Batfer Investment S.A., Montevideo (UY)

(72) Inventor: Drew Anderson, Minot, ND (US)

(21) Appl. No.: 19/142,478

(22) PCT Filed: Dec. 22, 2023
(86) PCT No.: PCT/US2023/085737

§ 371 Date: Jun. 23, 2025

Related U.S. Application Data
(60) Provisional application No. 63/435,420, filed on Dec. 27, 2022.

(51) Int. Cl. G01M 3/04

(52) U.S. Cl. CPC G01M 3/04

(57) ABSTRACT

An assembly for detecting gas emissions from a valve, including a shroud positioned over the bonnet of a valve assembly and a gas detector installed on the shroud. The gas detector is connected to a processor to determine the concentration of methane gas emitted through the valve assembly.

### CROSS REFERENCE TO RELATED APPLICATION

This application claims priority to U.S. Application No. 63/435,420 filed on Dec. 27, 2022, the disclosure of which is incorporated herein by reference for all purposes.

### FIELD OF THE INVENTION

The present invention relates to monitoring valve seal performance, and more particularly, to detecting methane leaks indicative of seal wear.

### BACKGROUND OF THE INVENTION

Oil and gas wells produce a fluid combination consisting of oil, gas, water, and solids in various concentrations. Wells are constructed to contain the free-flowing pressure of these fluids from the reservoir. The wellhead used to cap the well is a sequence of rings that retain tubular sections of pipe that are installed in the well. The wellhead is sealed using a series of valves installed on the wellhead, known as a production tree.

The valves used in the production tree are commonly gate valves, but can also be plug valves or ball valves, depending on the size and pressure required to maximize the flow from the well and the pressure of the fluids in the well.

During the life of the well, valves in the production tree are opened and closed as part of normal operations. The valves have seals on the flanges and internal seals on the bonnet that form the primary barrier to fluids.

As the elastomeric seals age, they can start to leak fluids. Gas molecules, being much smaller and more mobile, escape past the seals in small quantities and progressively the valve bonnet seals deteriorate allowing more gas to escape to atmosphere.

### SUMMARY OF THE INVENTION

In one aspect, the present invention relates to a system and method for the early detection of leaks in a valve.

In another aspect, the present invention relates to a system and method for monitoring methane emissions from the bonnet-stem interface of a valve.

### BRIEF DESCRIPTION OF THE DRAWINGS

FIG. 1 depicts one embodiment of the present invention on a manually-operated valve.

FIG. 2 depicts one embodiment of the present invention on an actuator.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements which perform the same functions across various embodiments. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

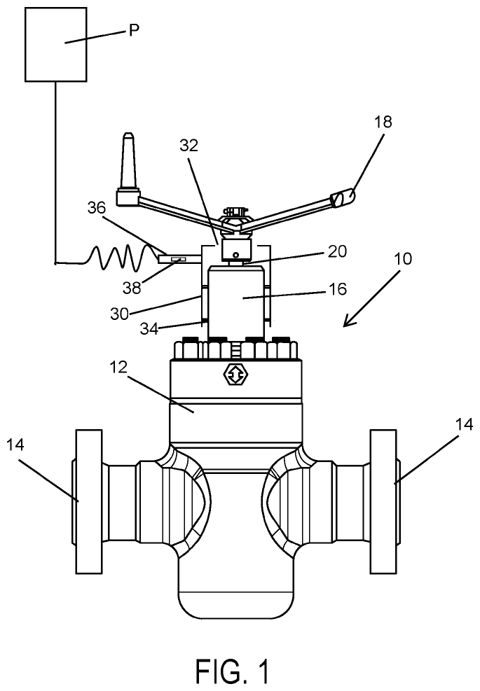

Turning to FIG. 1, there is shown generally as 10 a manually operated gate valve. It will be appreciated by those of skill in the art that this embodiment of the present invention can also be employed on a plug valve or ball valve. Gate valve 10 has a main body 12, and a plurality of openings 14 which form a flow path. It will be appreciated that the internal workings of the gate valve are well known to those skilled in the art and will not be discussed in detail. Atop body 12 is a bonnet 16. Handwheel 18 is used to operate gate valve 10. Turning handwheel 18 causes threaded shaft 20 to raise or lower (depending on the direction turned) into an opening (not shown) in bonnet 16, and in turn raising or lowering a valve element (not shown) to open or close the flow path.

Positioned over bonnet 16 is a shroud 30. Shroud 30 includes an opening 32 in the top to allow shaft 20 to extend through it. To install shroud 30, handwheel 18 is removed and shroud 30 positioned over bonnet 16. Shroud 30 may be of the slip fit type or, if desired, a plurality of O-rings or annular seals 34 can hold shroud 30 in place against bonnet 16. Once shroud 30 is correctly positioned, handwheel 18 can be reattached. It will be appreciated that seals 34 need not be air tight, but must simply have sufficient grip to keep shroud 30 from moving around. It will also be appreciated that while FIG. 1 shows two annular seals 34, the exact number and positioning of seals 34 may vary depending on the needs of the user.

Affixed to shroud 30 is a housing 36 in which is held a sensor 38. Housing 36 may be press fit or threaded into an opening in shroud 30. Sensor 38 is a methane gas sensor. Should the seals inside bonnet 16 start to leak, methane gas will escape through the opening in bonnet 16 through which shaft 20 extends. Sensor 38 will detect the levels of methane. In a preferred embodiment, sensor 38 is operatively connected to a processor P.

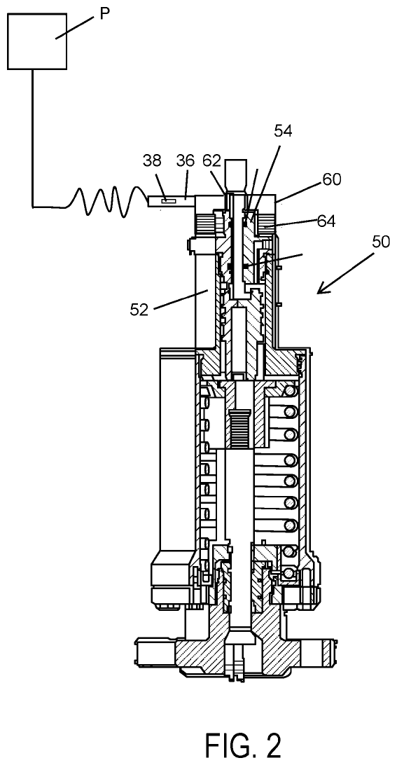

Turning to FIG. 2 is another embodiment of the present invention. The embodiment in FIG. 2 is similar to that of FIG. 1 but is designed to be positioned on an actuated valve. This embodiment works with hydraulically, pneumatically, or electronically actuated valves. Valve 50 has a bonnet 52 with a threaded cap 54. While the valve in FIG. 2 is depicted as a spring return valve, it will be appreciated that the invention can also work with a double acting valve. Shroud 60 is installed by lowering shroud 60 over the top of the cap 54. An opening 62 in shroud 60 allows the top of the actuator to extend therethrough. Shroud 60 is held in place on actuated valve 50 by means of a threaded ring 64 inside shroud 60. The threads of ring 64 are complementary to those of threaded cap 54. It will thus be appreciated that the exact thread configuration of threaded ring 64 can vary as needed. As with shroud 30, a housing 36 is connected to shroud 60 via press fitting or threading housing 36 into an opening in shroud 60. Housing 36 contains methane sensor 38. As with the previous embodiment, sensor 38 is preferably operatively connected to a processor P. Should seals 56 in the actuator start to fail, sensor 38 will detect the early emission of methane gas.

The signal sent from sensor 38 can be sent either by a cable or by wireless technology to processor P. The processor converts the signal to a percentage of lower gas explosion level (% LEL) or gas concentration (ppm). This data is sent for further processing against set points to determine if any alarms should be generated and/or actions taken.

The present invention has several advantages over the prior art. By detecting the leakage of gas, seal failure can be detected in the earliest stages and corrected before a large leak/damage occurs. By connecting the sensor to a processor, data regarding the failure rate of seals can be compiled and maintenance schedules adjusted accordingly. The shrouds 30, 60 of the present invention can be installed retroactively or incorporated into newly built systems. They are also easily installed and replaced.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. An assembly for detecting gas emissions from a valve, comprising:
a shroud positioned over a bonnet of a valve assembly;
a gas detector installed on said shroud.

2. The assembly of claim 1, further comprising:
a retention system to hold the shroud in place on said bonnet.

3. The assembly of claim 2, wherein said retention system consists of at least one annular seal.

4. The assembly of claim 2, wherein said retention system consists of a threaded ring.

5. The assembly of claim 1, wherein said valve assembly is manually operated.

6. The assembly of claim 1, wherein said valve assembly is hydraulically, pneumatically, or electronically actuated.

7. The assembly of claim 1, wherein said gas detector is operatively connected to a processor.

8. The assembly of claim 7, wherein said gas detector is connected to said processor wirelessly.
